(19) United States
(12) Patent Application Publication
(10) Pub. No.: US 2012/0272830 A1
(43) Pub. Date: Nov. 1, 2012

(54) DEVICE FOR PREPARING A BEVERAGE AND CAPSULE

(75) Inventor: Raphael Gugerli, Kilchberg (CH)

(73) Assignee: DELICA AG, Birsfelden (CH)

(21) Appl. No.: 13/516,544

(22) PCT Filed: Dec. 16, 2010
(86) PCT No.: PCT/EP2010/069874

§ 371 Date: Jun. 15, 2012

(30) Foreign Application Priority Data
Dec. 18, 2009 (EP) 09179979.1

(51) Int. Cl. A47J 31/00; B65D 85/804

(52) U.S. Cl. 99/295; 426/115

(57) ABSTRACT

The invention relates to a device (1) for preparing a beverage from a substance, which is contained in particular in a capsule, using a liquid medium. The device comprises two chamber parts (5), (6) that can be pressed against one another in a closed position to form a receiving chamber in which the capsule can be locked. Said receiving chamber comprises at least one drainage channel (12) leading from the chamber interior to the chamber exterior, with said channel being disposed on a wall section of one of the chamber parts (5) such that it can be sealed by the capsule (2) and/or by the other chamber part (6) when the closed position is being created.

The invention relates to a device for preparing a beverage as claimed in the preamble of claim 1. Recently these types of devices are used more and more frequently in order to prepare, for example, portions of coffee or tea at a level of quality which always remains constant. In this case, as a rule, a brewing process takes place in the receiving chamber where a metered amount of hot water is directed through the portion packaging. Examples of these types of devices are described in EP 1 646 305, WO 2008/004116 or WO 2008/087099.

One problem with these devices is that after the brewing process, the metered amount of water does not flow away completely in the form of extract. Rather, a certain amount of residual water remains behind in the brewing chamber and drains away subsequently when the brewing chamber is opened to remove the used portion packaging. However, this is undesirable because the residual water contaminates the appliance or the next beverage prepared. Some contamination takes place, in particular, whenever different types of beverage are prepared using the same machine, such as, for example, coffee, tea, milk or chocolate beverages. If residual water remains behind in the closed chamber for a fairly long period, there is also the risk that a fermentation process will begin which results in irreversible changes in taste in the brewing chamber. Residual water can also remain behind in the brewing chamber for a fairly long time after a rinsing operation.

A further disadvantage of known devices is also that the outlet opening on the receiving chamber becomes clogged, it being possible for an internal pressure of about 20 bar to occur. At a pressure of this type, seals are pressed open and brewing water sprays into the machine or, in the extreme case, even outward through the input opening even when the machine has already been switched off.

DE 20 2005 021 159 proposes preventing possible residual water flowing out in an unwanted manner by means of a spring-loaded closure member which does not open until the brewing chamber is closed. However, this does not really solve the problem because the residual water flows out nevertheless when the chamber is closed and is held back when the chamber is open which means that it flows out during the next closing process.

WO 2009/115474 has made known a generically comparable device where the edge of the chamber parts, which can be pressed against each other, has gaps on at least one chamber part. Said gaps are arranged inside a defined sector such that when there is no capsule in the chamber, water flows out in a targeted manner. Sealing said gaps is only possible using capsules which have a deformable sealing material on their flange-like edge. It is not possible to close the chamber in a sealing manner without a capsule. Neither is it possible, however, to conduct away excessive fluid with the chamber closed and the capsule inserted, for example under overpressure, because the gaps at the edge are closed off in a pressure-tight manner in the closed state.

It is, consequently, one object of the invention to create a device of the aforementioned type where residual water remaining behind is able to be conducted out of the brewing chamber without the already prepared beverage or the device becoming contaminated. This object is achieved as claimed in the invention with a device which has the features in claim 1.

The initial effect of the drainage channel leading from the chamber inside to the chamber outside is that the residual water is not conducted away by means of the outlet which is provided for the finished beverage. Nevertheless, the drainage channel remains closed during the brewing process because it is arranged in such a manner on a wall section of a chamber part that it can be sealed by means of the portion packaging and/or by means of the other chamber part when the closed position is set up. This sealing during the brewing operation is important for this latter takes place in part under a pressure of more than 10 bar. As soon as the brewing chamber is opened or the portion packaging is removed, the remaining residual water is able to flow away by means of the drainage channel. In certain cases, it can even be sufficient when the overpressure in the brewing chamber decreases such that the sealing action generated by the portion packaging is lifted.

The drainage channel deploys its advantageous effect, however, directly after the brewing operation when the receiving chamber has been emptied and subsequently closed again. The process of ejecting, for example, one coffee capsule is not sufficient namely to remove all the residual water still situated in the lines. The drainage channel makes it possible for all the residual liquid to drain away from the time the machine is non-operational up until the next brewing operation. The drainage channel also acts, however, as a pressure relief valve when high internal pressure builds up. The drainage channel is opened namely before the seals can be pressed against the receiving chamber. Surplus water or even vapor are consequently conducted away by means of the drainage channel. This ensures that no sensitive machine parts such as, for example, electronic assemblies etc. can be damaged. Finally, the drainage channel also brings about optimum rinsing of the brewing chamber. The additional opening at the receiving chamber brings about namely a reduction in counter pressure during the rinsing process and consequently a greater flow rate of the rinse liquid per unit time. In particular, the drainage channel also ensures rapid emptying and drying of the receiving chamber after a rinsing operation.

It can be particularly advantageous when the drainage channel has on the chamber inside a mouth opening which is sealable by means of an outside wall section of a portion packaging enclosed in the chamber. The portion packaging can be a capsule, a pouch or another provided form. Obviously the outside configuration of the portion packaging and the inside configuration of the chamber in the region of the mouth opening must be matched to each other such that the desired sealing action is able to be generated.

However, as an alterative to this or supplementing it, the drainage channel can also be sealable by means of a closure body which is associated with the other chamber part. The closure body, for example, can be a valve body which engages directly in the drainage channel when the chamber is closed and blocks it. It would also be conceivable, however, for the drainage channel to be held in the open position by means of a spring-loaded valve when the chamber is open, the closing body on the other chamber part purely displacing the valve into the closed position. The closing body does not forcibly have to be arranged directly on the other chamber part. An indirect operative connection to another component would also obviously be conceivable.

In the case of the portion packaging being realized as a capsule, it is advantageous when one of the chamber parts is realized as a holder with a cavity for receiving the portion packaging and the other chamber part is realized as a closure part for closing the cavity and for the drainage channel to be arranged on the holder. The drainage channel can be positioned in an optimum manner in this way. In this case, how the two chamber parts are moved is basically not significant. Obviously, it would also be conceivable for the drainage channel to be arranged on the closure part. Depending on the realization of the portion packaging, the two chamber parts could also be realized in a completely symmetrical manner. An arrangement of several drainage channels on one or on both chamber parts would also be conceivable.

Further advantages can be achieved when the cavity has at least one drainage groove which, with reference to a longitudinal center axis, extends preferably from the bottom of the cavity toward the opening thereof. The drainage groove simplifies the conducting away of the residual water in particular also from the bottom region and over the entire length of the brewing chamber. In addition, the drainage groove has the advantageous effect that it simplifies the ejecting of the capsule because the suction action between the inside wall of the cavity and the outside wall of the capsule is reduced or eliminated. The drainage groove can extend in a linear manner over the length of the cavity. However, the form of a spiral or another configuration would also be conceivable.

In addition, the cavity, on the side of its opening, can have a support shoulder, which is inclined preferably at a right angle with respect to the longitudinal center axis, for supporting a complementary wall part of the portion packaging, wherein the drainage groove opens out into the support shoulder and the drainage channel begins in the support shoulder or in a region which adjoins directly thereto.

In this way, the portion packaging closes not only the drainage channel in the closed. position, but also at the same time the end of the drainage groove on the opening side. It is obviously advantageous when the drainage groove opens out into the support shoulder on the same radial plane on which the mouth opening of the drainage channel also lies.

To achieve a flow through the portion packaging, at least one chamber part can have at least one penetration element for penetrating the portion packaging in the closed position. Both chamber parts are preferably provided with at least one penetration element each, both sides of the portion packaging having to be penetrated in the closed position, however not forcibly. In the case of certain systems, penetration is effected on the outlet side first by means of deforming the portion packaging or by exceeding a tearing stress when building up an internal pressure. However, portion packagings are also known which are themselves provided with penetration means which are activated when a pressure is built up. Complicated portion packagings with in-built valves, which are opened by closing the brewing chamber or by means of the effect of pressure, are also known.

The drainage channel can have a cross section which is smaller than the cross section of the inlet opening and/or of the outlet opening. The cross section of the drainage channel is preferably between 0.1 mm² and 10 mm². The advantage of the relatively small cross section of the drainage channel compared to the inlet opening or the outlet opening is that it is possible to rinse the brewing chamber, the greater part of the rinse water flowing through the outlet opening and only a smaller part through the drainage channel.

In order to prevent the liquid drained away via the drainage channel contaminating the device, it is advantageous when the drainage channel leads to a vessel for receiving the drained liquid. In this case, for example, this can be the drip pan which is arranged anyway underneath the outlet for the beverage. The drainage channel could be connected to a pipe line or to a hose line for this purpose.

Finally it is advantageous when the receiving chamber is realized in a rotationally symmetrical manner and when the drainage channel is realized as a radial bore in one of the chamber parts. In the case of capsule systems usual today, the longitudinal center axis of the brewing chamber, as a rule, always extends approximately horizontally because the capsules reach their intermediate position under the effect of gravity before they are enclosed in the brewing chamber. A radial bore as the drainage channel is the shortest possible connection between the inside and the outside of the chamber. In this case, the radial bore can be arranged at the lowest point of the brewing chamber such that the residual water flows away downward. Obviously, the drainage channel does not have to extend in a radial manner with respect to the longitudinal center axis of the chamber. Depending on the design of the device, it could also extend over certain sections in an almost parallel manner with respect to said longitudinal center axis. The cross section of the drainage channel does not forcibly have to be circular either. The important thing in each case is that the drainage channel is designed such that liquid is able to flow downward under the effect of gravity. In certain cases, however, the drainage channel could also extend between the chamber inside and the chamber outside onto an elevated plane. This could be the case, for example, when a vaporous medium such as, for example, water vapor is to be conducted out of the chamber.

The conducting away of liquid via the drainage channel can be improved further when a drip skirt is arranged in the region of the outlet opening of the drainage channel on the chamber outside in such a manner that outflowing liquid can be conducted away along the drip skirt. The drip skirt preferably extends in a vertical plane and it can further be provided with a groove which leads to the outlet opening in order to promote the dripping of liquid. The drip skirt also forms protection for the opposite chamber part because it prevents liquid getting into the sealing zone between the two chamber parts and contaminating them.

The invention also relates to a capsule with the features of claim 12, said capsule being able to be inserted in a particularly advantageous manner in the above-described device. The circumferential shoulder with the wall section which is inclined or curved in cross section enables the capsule to be supported in an advantageous manner in the brewing chamber, the outside of the shoulder forming a sealing surface which can be pressed in a sealing manner against a complementary contact surface. In order to be able to achieve an optimum sealing action, the width of the wall section should be at least 1 mm. The height of the shoulder is preferably at least 3.5 mm in order to obtain a sufficiently large sealing surface. The term width, in this case, refers to the projection measurement, that is to say the width when measured at a right angle to the longitudinal center axis of the chamber. However, the relatively pronounced circumferential shoulder on the capsule has even more advantages. On the one hand, as is already known per se from WO 2008/087099, it can form a stacking edge which makes it possible to stack the still empty capsule bodies one on top of the other such that they can be better singled-out in the filling system. In addition, however, the shoulder also brings about a change in the direction of flow of the brewing water pressed into the capsule under pressure. Said water tends namely to look for a channel directly along the capsule wall in order to arrive at the outlet opening along the shortest path. This process is also referred to as “channeling” and obviously results in the extraction only draining away in an incomplete manner. The circumferential shoulder, in contrast, causes the flow to be diverted in a concentric manner toward the interior of the capsule such that no troublesome through channels can be formed on the inside wall of the capsule.

In addition, it is advantageous when the inclined wall section of the capsule is inclined by 45° with respect to the longitudinal center axis tapering toward the bottom. In this way, the acting closing forces are shared out in an optimum manner on the inclined surface. In addition, the side wall of the capsule between the bottom and the shoulder can be realized tapering toward the bottom, preferably inclined by an angle of 7° with respect to the longitudinal center axis.

Further advantages can be achieved when the capsule is deep-drawn from a film of plastics material. Films of a biopolymer such as, for example, starch or of metal or of a laminate are also conceivable. In contrast to capsules which are produced using the injection molding method, deep-drawn capsules have considerably more elasticity. This improves the sealing effect of the capsule at its shoulder in a considerable manner. In this case, it is particularly advantageous to realize the bottom of the capsule so as to be resiliently deformable toward the interior of the capsule. This is achieved in an advantageous manner by the radius at the transition from the bottom to the side wall being realized thinner than the bottom itself. The transition region, in this case, could have a wall thickness of up to 0.18-mm and the bottom could have a wall thickness of between 0.1 and 0.2 mm. As a result, penetration means present in the receiving chamber initially cause the capsule bottom to bulge toward the interior and, if needs be, the capsule bottom to be lightly pierced.

Further advantages during the brewing process can be achieved when at least one of the chamber parts has compression means which are directed against the receiving chamber and by means of which the portion packaging can be acted upon in the closed position. Said compression means are preferably used in combination with the aforementioned penetration means, preferably in such a manner that they act upon the edge region of the capsule cover. This means that the cover of the capsule is stretched tightly such that the penetration means are better able to penetrate and inflowing water is distributed over the entire cover surface. The compression means, in this case, can be realized cylindrically in the manner of a bolt or also square-shaped. The end face of said compression means can be rounded or angular. In certain cases, a combination of compression means and penetration means would also be conceivable.

The compression means can also comprise at least one resilient element which has a plurality of leaf springs which extend radially outward proceeding from a center and the resilient free ends of which act upon the portion packaging in the closed position. In this case, the arrangement of the individual leaf springs is in the manner of the legs of a spider. Penetration elements and/or further compression means, for example in the form of bolts can be arranged on the chamber part between individual or all of the leaf springs. The ends of the leaf springs not only span the cover film of a capsule but they also prevent the capsule getting stuck fast on the penetration means when the chamber is opened. The force of the leaf springs is dimensioned in such a manner that a penetrated capsule is pushed off when the chamber is opened. An arrangement of this type would obviously be extremely advantageous and expedient even in the case of conventional devices without a drainage channel.

On a device as claimed in the invention it is further expedient when the side wall of the capsule used is radially expandable under the effect of pressure, the drainage channel being sealable by means of the sealing surface of the expanded side wall. The receiving chamber, in this case, can be dimensioned such that the capsule is able to expand in a radial manner by more than 1 mm during an extraction under pressure. In this way, the capsule does not have to be dimensioned in a very precise manner to achieve the sealing effect.

Further advantages and features of the invention proceed from the following description of exemplary embodiments and from the drawing, in which:

FIG. 1 shows a perspective representation of a coffee machine when loading a capsule,

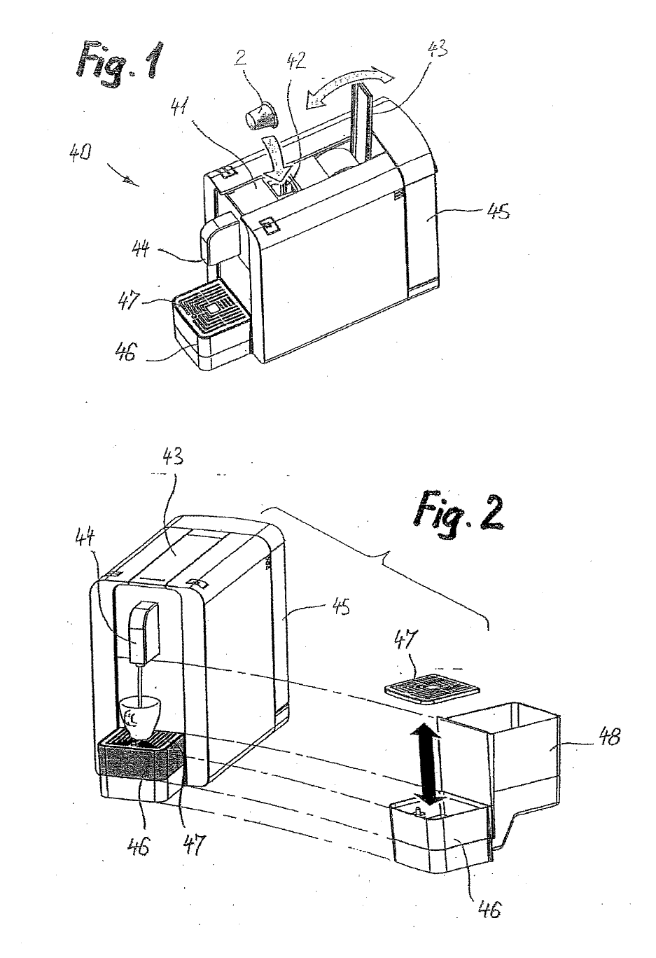

FIG. 2 shows the coffee machine according to FIG. 1 when discharging the beverage and with a receiving container shown separately,

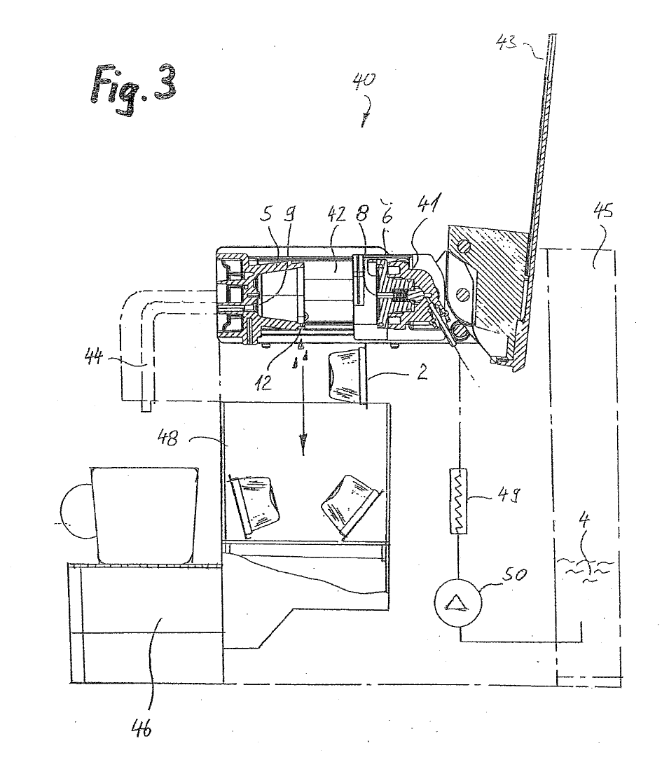

FIG. 3 shows a greatly simplified representation of a cross section through the coffee machine according to FIG. 1 and with a device as claimed in the invention,

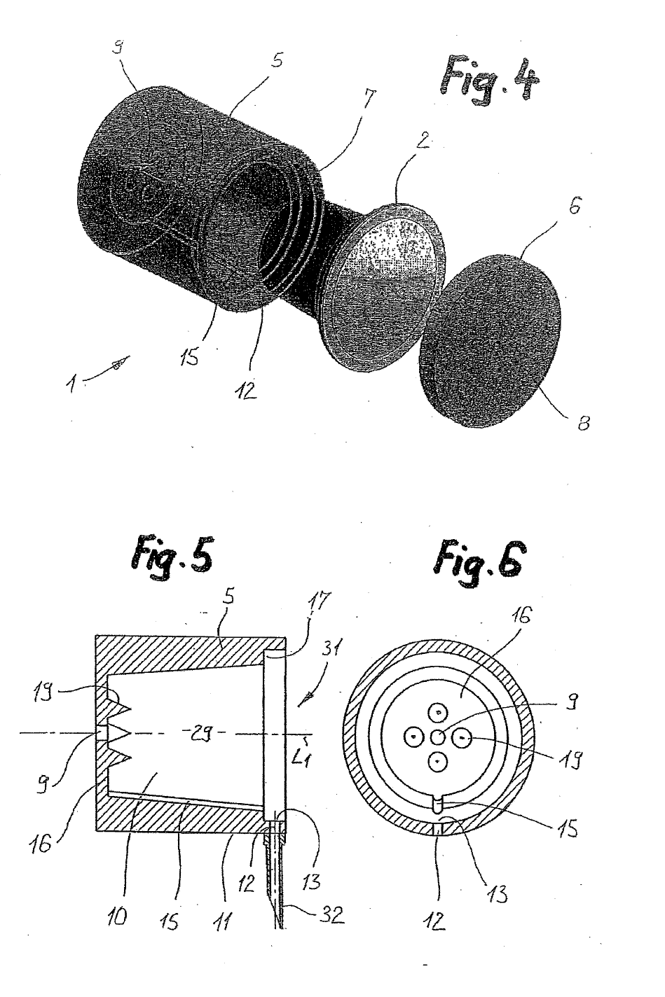

FIG. 4 shows a perspective representation of a capsule holder with capsule and closure part,

FIG. 5 shows a longitudinal section through a capsule holder,

FIG. 6 shows a cross section through the capsule holder according to FIG. 5 in the region of the drainage channel,

FIG. 7 shows a perspective longitudinal section through the arrangement according to FIG. 4,

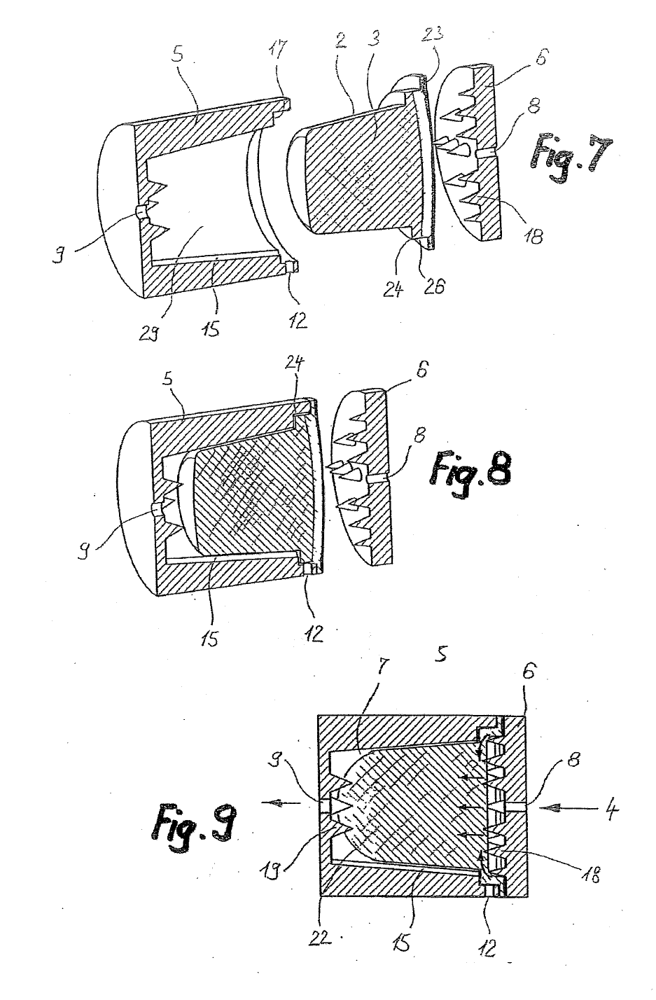

FIG. 8 shows the arrangement according to FIG. 7 shortly before the receiving chamber is closed,

FIG. 9 shows a longitudinal section through a closed brewing chamber during the brewing process,

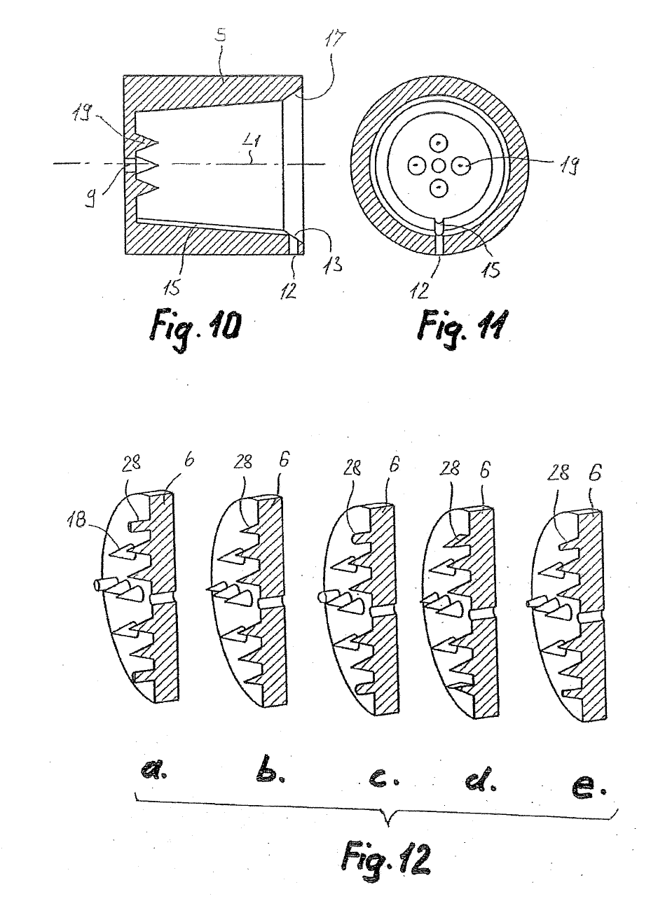

FIG. 10 shows a longitudinal section through a modified exemplary embodiment of a receiving chamber,

FIG. 11 shows a cross section through the receiving chamber according to FIG. 10 in the region of the drainage channel,

FIG. 12 shows various exemplary embodiments of closure parts with alternative compression means,

FIG. 13 shows a longitudinal section through an alternative exemplary embodiment with the drainage channel which is closable by the closure part,

FIG. 14 shows a perspective representation of a capsule as claimed in the invention,

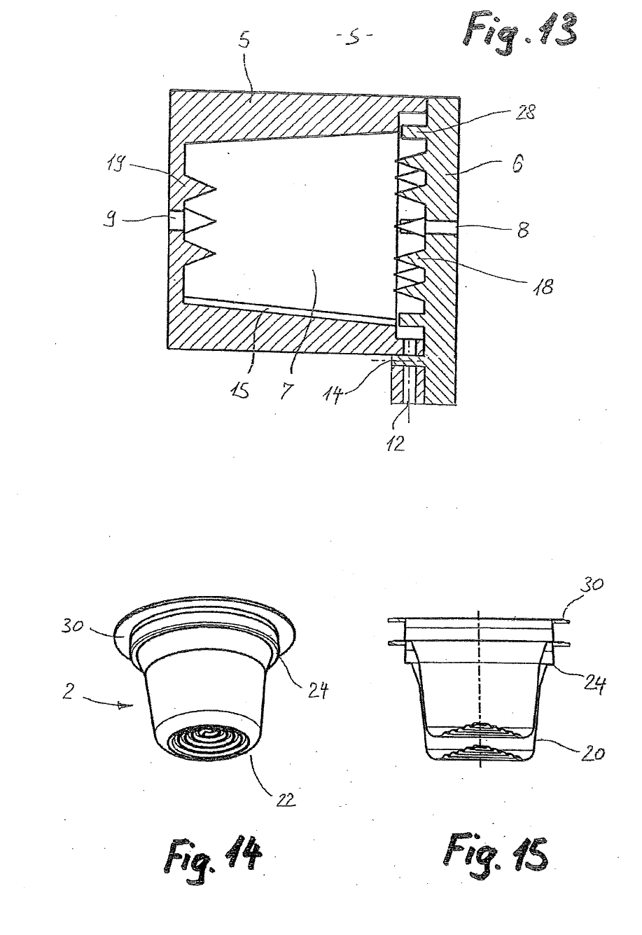

FIG. 15 shows a section through two stacked capsule bodies,

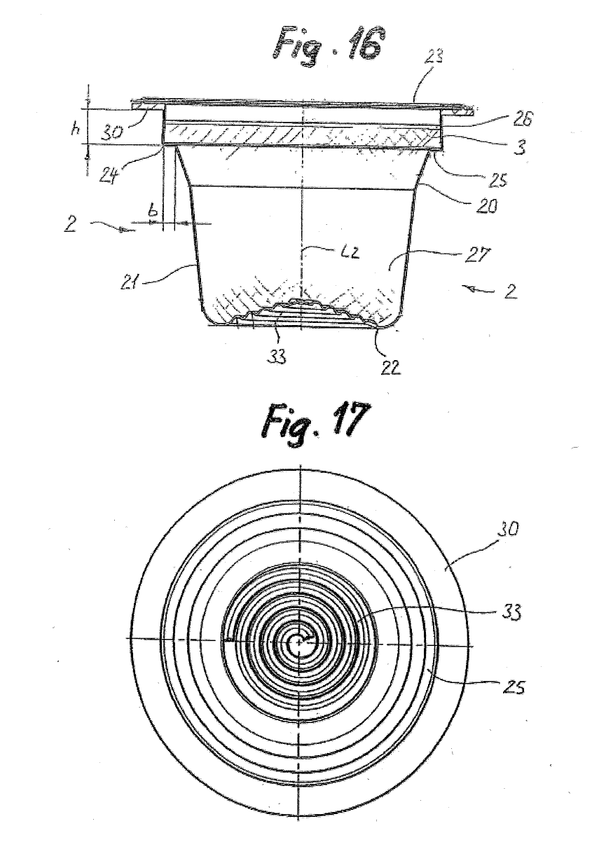

FIG. 16 shows an enlarged representation of a section through a capsule as claimed in the invention,

FIG. 17 shows a top view of the bottom of the capsule according to FIG. 16,

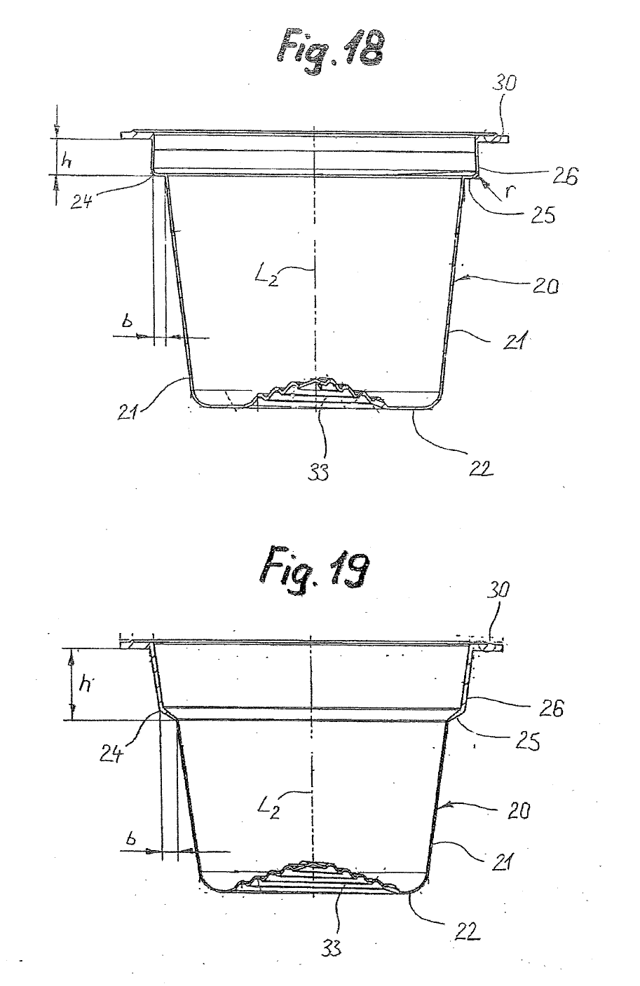

FIG. 18 shows a section through a capsule body according to a further exemplary embodiment,

FIG. 19 shows a section through a capsule body according to a further exemplary embodiment,

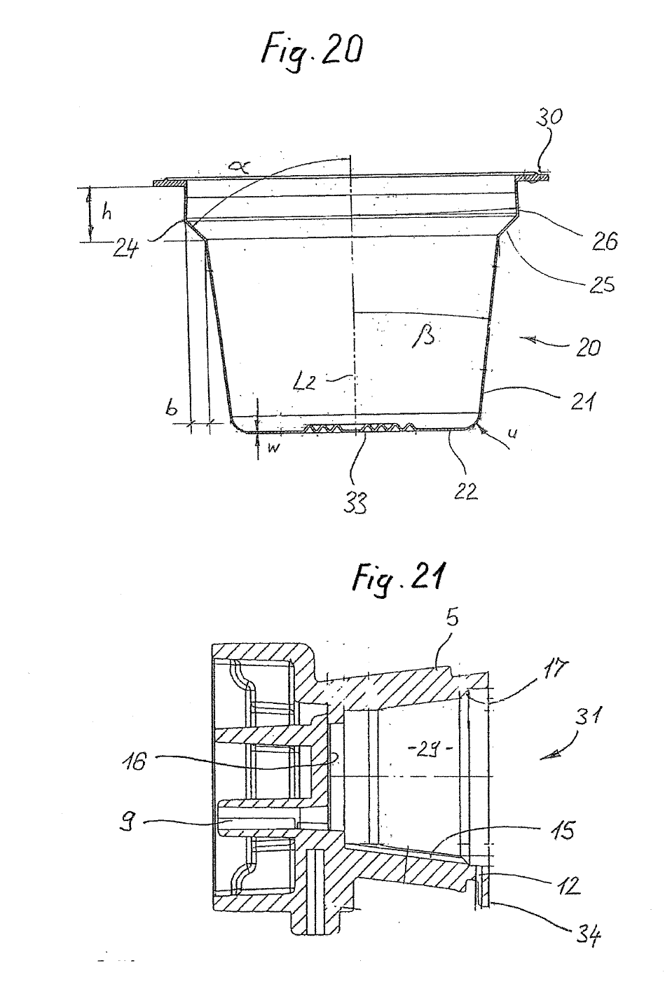

FIG. 20 shows a section through a capsule body according to yet another modified exemplary embodiment,

FIG. 21 shows a longitudinal section through a capsule holder according to a further embodiment,

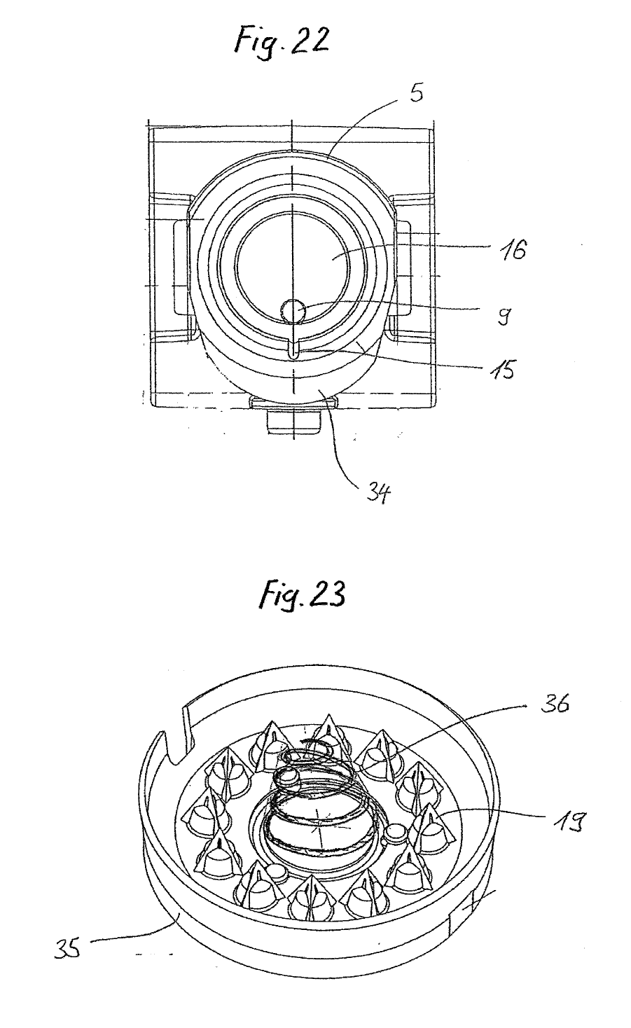

FIG. 22 shows a top view of the opening of the capsule holder according to FIG. 21,

FIG. 23 shows a perspective and enlarged view of a bottom sieve plate for insertion into the capsule holder according to FIG. 21,

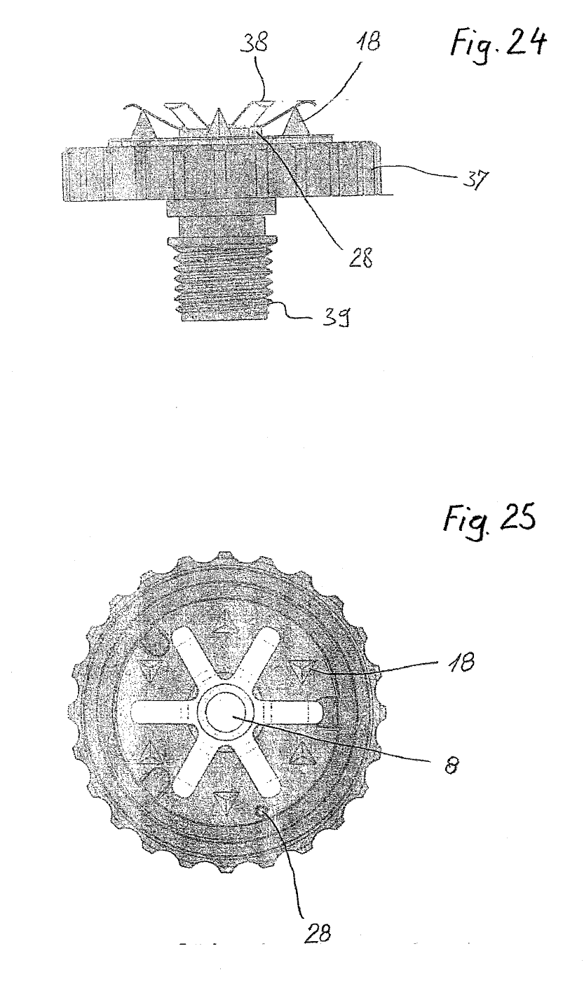

FIG. 24 shows a side view of an injector plate with leaf springs and

FIG. 25 shows a top view of the injector plate according to FIG. 24.

FIG. 1 shows a coffee machine given the reference 40, where a coffee capsule 2 can be supplied in a known manner per se to a brewing module 41 through an input opening 42. By means of an actuating lever 43, the capsule is moved in the manner described again below into a brewing position in which a metered amount of coffee is output (FIG. 2) at the outlet 44. For this purpose, the coffee machine has a water tank 45. A drip tray 46, which is covered by a sieve 47, is arranged underneath the outlet 44.

FIG. 2 also shows the capsule container 48, which is connected to the drip tray 46, however is not visible from the outside and receives the used capsules 2 as well as any residual water from the brewing chamber.

This situation is shown in FIG. 3. When the actuating lever 43 is pushed back after the brewing process, the used capsule 2 falls downward into the capsule container 48. The brewing module 41, in the case of the present exemplary embodiment, has a holder 5 for receiving the capsule, said holder being arranged in a relatively fixed manner. The closure part 6 for closing the brewing chamber is movable against the holder 5 in a linear manner by means of the actuating lever 43.

Once the capsule has been ejected, the actuating lever 43, as a rule, is closed again such that the brewing chamber is once again in the sealed closed position, the same as in the case of the brewing operation. Residual water is able to drip away via the drainage channel 12 even in this inoperative position of the coffee machine.

An inlet opening 8 is arranged on the closure part 6 and an outlet opening 9 is arranged on the holder 5. Said outlet opening leads directly to the outlet 44. The brewing water 4 in the tank 45 is supplied to the inlet opening 8 via a pump 50 and a flow heater 49. When the brewing module is closed by activating the lever 43, a capsule that was inserted beforehand is penetrated by way of penetration means (not shown here) such that the brewing water is able to flow through the capsule. A drainage channel 12, the function of which will be described in more detail below, is arranged on the bottom edge of the holder 5.

FIG. 4 shows a device 1 as claimed in the invention in a greatly simplified manner, said device being a component of the brewing module shown in FIG. 3. The closure part 6 and the holder 5 are pressed against one another and thus form a receiving chamber 7 for the capsule 2.

Details of the holder are shown in FIGS. 5 and 6. The holder 5 has a cavity 29, which is adapted to the form of the capsule and in the present case is realized in the form of an approximately truncated cone. The outlet opening 9 is arranged on the bottom 16 of the cavity. A total of four penetration elements 19, the number and arrangement of which can naturally vary in an arbitrary manner, are arranged around the outlet opening. The cavity 29 has a support shoulder 17 on the side of its opening 31 and a drainage channel 12, which extends as a radial bore from the chamber inside 10 to the chamber outside 11, is also arranged in the region of the opening. The mouth 13 of the drainage channel is located in the widened opening region in front of the support shoulder 17. A drainage groove 15, which is located on the same radial plane as the drainage channel 12, extends from the bottom 16 of the cavity as far as up to the support shoulder.

FIG. 5 further shows that the drainage channel 12 can continue in a drip channel 32. The angular tip of said channel promotes the dripping of liquid. In certain cases it would obviously also be conceivable for the drainage channel to open out into a flexible hose.

FIG. 7 once again shows approximately the same situation as FIG. 4, but in cross section through the radial plane of the drainage channel 12 and of the drainage groove 15. In addition, it is also possible to see here the penetration elements 18 on the closure part 6 which are able to penetrate the cover 23 of the capsule 2. The capsule 2 is filled, for example, with relatively compactly pressed coffee powder 3. In addition, a circumferential shoulder 24 directly below the capsule collar 30, the outside of which in total forms a sealing surface 26, can also easily be seen here.

FIG. 8 shows an operating position where the capsule 2 has already been inserted into the cavity 29 of the holder 5. The closure part 6, however, has not yet been pressed in a sealing manner against the holder 5. As shown, the circumferential shoulder 24 fits in an approximately complementary manner onto the circumferential shoulder 17 on the holder 5. In this case, the drainage channel 12 is also closed, but not yet sealed in a pressure-tight manner. Together with the outer wall of the capsule, the drainage groove 15 forms a closed channel which is, however, not yet sealed in a pressure-tight manner either.

FIG. 9 shows the situation during the brewing operation where the brewing water 4, shown by way of the arrow, is pressed through the inlet opening 8 under pressure into the closed receiving chamber 7, the coffee extract emerging from the outlet opening 9. The penetration elements 18 have already penetrated the cover 23 of the capsule when the chamber 7 was closed and the incoming brewing water presses the cover 23 of the capsule toward the interior of the capsule such that the brewing water is distributed over the entire surface of the cover and penetrates through the created openings into the interior of the capsule. The circumferential shoulder 24 of the capsule, in this case, causes the incoming brewing water in the edge region to be guided toward the center of the capsule, which is shown by way of the curved arrows. This prevents the brewing water being able to look for a channel between the capsule wall and the pressed coffee in the edge region, which would result in incomplete extraction.

Under the effect of the internal pressure, the bottom 22 of the capsule bulges outward such that it is also penetrated by the penetration elements 19 at the bottom of the cavity. It would also be conceivable for the bottom and the cover of the capsule to be penetrated at the same time when the chamber is closed.

Under the effect of the internal pressure the circumferential sealing surface 26 of the capsule is also pressed against the mouth of the drainage channel 12 such that said drainage channel is closed in a sealing manner. It is nevertheless ensured that if excessive internal pressure is built up in the chamber 7, the liquid can create a path to the outside of the chamber via the drainage groove 15 and the drainage channel 12. The drainage channel 12 consequently also fulfills the function of a pressure relief valve. Once the brewing process has been completed, that is to say once the pressure in the chamber 7 has been reduced, surplus liquid can immediately be drained away again via the drainage channel 12, even before the brewing chamber is opened again. This prevents surplus liquid being able to be reduced exclusively via the outlet opening 9.

It would obviously also be conceivable for just the drainage channel 12, but not the mouth of the drainage groove 15, to be closed during the brewing process. Under certain conditions, however, even just the mouth of the drainage groove could be closed which, in practice, then takes on the function of a drainage channel itself.

FIGS. 10 and 11 show an alternative embodiment of a holder 5. The single difference between said holder and the exemplary embodiment according to FIGS. 5 and 6 is that the circumferential shoulder 17 is not realized at a right angle with respect to the longitudinal center axis L1 of the cavity but at an angle thereto. The shoulder 17, in this case, forms a cone, the outside surface of which intersects both the mouth of the drainage channel 12 and the end of the drainage groove 15.

Further cross sectional configurations of the shoulder 17 are obviously conceivable. Said shoulder could also extend in a curved manner, in particular in an arcuate manner. The important factors in each case in all the configurations are a sufficient width and a sufficient height so that a sufficient sealing surface remains present around the mouth 13 of the drainage channel.

FIG. 12 shows a total of five different variants of closure parts 6. The special point about said closure parts additionally is also that along with the aforementioned penetration elements 18, additional compression means 28 are also arranged in particular in the outside region. The primary object of said compression means is not to penetrate the cover of the capsule as quickly as possible. Rather, the compression means are to clamp the cover of the capsule in the edge region, as is shown in the closed position S according to FIG. 9. The clamping of the capsule cover ensures that the incoming brewing water is distributed over the entire surface. However, the compression means could also have a dual function by also penetrating the capsule cover in a complete or partial manner at least in a final phase of the closing operation. The mentioned compression means develop their optimum effect independently of the drainage channel 12 which means that they are able to be used even in the case of conventional devices without a drainage channel.

According to FIG. 12a, the compression elements 28 are realized in a cylindrical manner. In total there are four such elements distributed over the outside edge of the closure part 6 at a regular angular distribution of 90°. According to FIG. 12b, the compression elements 28 are also realized as cone points which differ from the remaining penetration elements only by their height. FIG. 12c shows the compression elements as cylinders which are rounded on the outside in a dome-shaped manner. Said compression elements are obviously not able to penetrate the cover of the capsule. The number and arrangement of the compression elements can obviously vary in an arbitrary manner. It would be conceivable also for just one single compression element to be present. Said compression element could also be, for example, in the form of a ring which surrounds the penetration elements.

According to FIG. 12d, the penetration elements 28 are shown as wedges. Finally, FIG. 12e shows another variant where the compression elements 28 are realized in cross section in a trapezoidal manner. The elements, in this case, could be realized both as flattened wedges or in the form of truncated cones. Obviously, it would also be conceivable to have other arbitrary variants of such compression elements which, depending on the development of the capsule, could also extend over different regions of the closure part.

FIG. 13 shows an alternative variant of a device 1 where the drainage channel is sealed in the closed position S even without the capsule inserted. For this purpose, the closure part 6 has a closing body 14 which can be realized, for example, in a cylindrical or block-shaped manner. In the closed state S shown, said closing body blocks the drainage channel 12 like a shut-off member on a valve. In the case of this development, the receiving chamber 7 is able to be rinsed with hot water without the rinse water escaping via the drainage channel 12.

FIG. 14 shows an outside view of a capsule which is described in more detail by way of FIGS. 16 and 17. As can be seen from FIG. 15, the circumferential shoulder 24 also allows for the empty capsule bodies 20 to be stacked in an advantageous manner prior to filling and sealing. A so-called stacking edge is certainly already known in the case of conventional capsules.

As can be seen from FIGS. 16 and 17, the actual capsule body 20, comprising side wall 21, bottom 22 and circumferential shoulder 24, is closed by means of a cover 23 which is soldered or bonded to the circumferential capsule collar 30. The substance 3, for example coffee, forms a compact cake in the capsule chamber 27, the surface of said cake ending directly underneath the cover 23. The entire outside of the shoulder 24 forms a sealing surface 26 which is capable of being placed in a sealing manner against a complementary surface on the brewing chamber. The wall section 25, which in the present case extends approximately at a right angle with respect to the longitudinal center axis L2 of the capsule, has a width b of preferably more than 1 mm. In the closed position S of the brewing chamber, said wall section is located in a sealing manner against the end of the drainage groove 15 (see FIG. 9). The height of the shoulder 24, with reference to the longitudinal center axis L2, is preferably at least 3.5 mm, measured from the attachment of the wall section 25 as far as up to the capsule collar 30. In exceptional cases, e.g. in the case of a drainage channel with a very small diameter, this measurement could also be less.

FIG. 18 shows a capsule body 20 without a cover and without the capsule contents with an alternative cross sectional configuration. In particular, in cross section the circumferential shoulder 24 is realized in a rounded manner with a radius r. The width b of the shoulder in the projection, in this case, can be the same as in the case of the exemplary embodiment according to FIG. 16. The capsule side wall 21 is not realized either here in a two-stage conical manner as in the case of the exemplary embodiment according to FIG. 16, but rather it extends directly from the circumferential shoulder 24 with the wall section 25 to the bottom 22. This latter is also developed in a somewhat different manner because the bellow-type spiral 33 has a smaller outside diameter such that a circular bottom surface remains. The object of the bellow-type spiral 33 is to realize the bottom 22 in a flexible manner in this region such that the bellow expands toward the capsule interior in the event of counter pressure.

FIG. 19 shows a capsule body 20 where all the lateral wall parts, that is to say the sealing surface 26, wall section 25 and the rest of the side wall 21 taper toward the bottom 22. Compared to the width b of the wall section 25, the height h of the shoulder 24 is greater than in the previously described cases. The height here could be, for example, 8 mm.

Obviously, different configurations of the brewing chamber and/or of the capsule or of the portion packaging are conceivable overall without departing from the object of the invention. Thus, for example, several drainage channels could be arranged at different points of the chamber parts. The same also applies to the described drainage groove, wherein it could also be possible to arrange said drainage groove on the capsule.

FIG. 20 shows a further capsule body where the height h of the shoulder 24 is realized smaller compared to the exemplary embodiment according to the FIG. 19. The width b of the shoulder is approximately the same, but the angle a with respect to the longitudinal center axis L2 is realized somewhat smaller such that a slightly larger surface is produced in the region of the wall section 25. The angle a in the present exemplary embodiment is precisely 45°. A further difference to the capsule according to FIG. 19 is that the spiral deformation 33 on the bottom is realized in a totally flat manner and does not bulge toward the capsule interior. Consequently, the fill volume of the capsule can be slightly increased. In the present exemplary embodiment, the angle of inclination of the side wall 20 between the shoulder 24 and the bottom 22 is precisely 7°.

The bottom 22 of the capsule can have a wall thickness w of, for example, between 0.1 and 0.2 mm, whilst the wall thickness in the rounded transition region u can be just between 0.1 and 0.18 mm. The transition region acts in the same way as a bending joint which facilitates the bottom deforming inward in a flexible manner.

The basic principle of the design of the capsule holder 5 according to FIG. 21 is the same as that according to FIG. 5. The inside configuration of the cavity 29 is adapted to the outside configuration of the capsule according to FIG. 20. The outlet opening 9 is not arranged in the center but in the bottom region. The penetration elements, in this case, are not integrated into the bottom 16 of the cavity. Rather, a recess, into which the bottom sieve plate described below is fitted, is provided there. The drainage channel 15 extends as a continuous groove as far as up to the support shoulder 17. A drip skirt 34 is arranged directly next to the drainage channel 12 and extends parallel to said drainage channel. As can be seen from FIG. 22, said drip skirt extends over a certain sector on the outside of the holder. The drainage channel itself is continued as a groove on the rear side of the drip skirt such that outflowing liquid is also removed from the drainage channel by the capillary action of the groove.

FIG. 23 shows a perspective view of a bottom sieve plate 35 which can be inserted into the bottom of the holder according to FIG. 21. A helical spring 36, the object of which is to eject the capsule from the holder once the chamber has been opened, is fixed in the center. A plurality of penetration elements 19, by means of which the extract can be removed from the capsule, is arranged around the center. The sieve plate 35 can be produced, for example, from plastics material or also from a ceramic material.

Finally, FIGS. 24 and 25 show another injector plate 37 which can be inserted, for example, into a coffee machine according to FIG. 3 (corresponding to closure part 6). The injector plate has a screw thread 39 for this purpose. A continuous inlet opening 8, by means of which, for example, hot water can be introduced into the capsule, leads through the center. A leaf spring arrangement 38, comprising a total of six individual leaf springs which extend radially outward, is fastened on the upper surface of the injector plate and around the inlet opening 8. One penetration element 18 each, in the form of a pyramid with relatively sharp edges, is arranged in the circumferential region between the individual leaf springs. As can be seen from FIG. 24, the free ends of the leaf springs project beyond the tips of the pyramids in the unstressed state. The cover film of a capsule is consequently already tensioned before the tips of the pyramids penetrate. In addition, a single compression element 28 in the form of a bolt is also arranged at a single position on the upper surface. A sealing lip, which is produced from resilient material and presses against the circumferential collar of the capsule in the closed state, can be arranged in the outermost circumferential region of the injector plate.

1-21. (canceled)

22. A device for preparing a beverage from a substance which is contained in a portion packaging, using a liquid medium, said device having two chamber parts which can be pressed against each other in a closed position to form a receiving chamber in which the portion packaging is enclosable, wherein the receiving chamber has at least one inlet opening and at least one outlet opening and the liquid medium is conductable through the portion packaging in the closed position, wherein the receiving chamber has at least one drainage channel, which leads from the chamber inside to the chamber outside and is arranged in such a manner on a wall section of one of the chamber parts that it can be sealed by means of the portion packaging and/or by means of the other chamber part when the closed position is set up.

23. The device as claimed in claim 22, wherein on the chamber inside, the drainage channel has a mouth opening which can be sealed by means of an outside wall section of a portion packaging enclosed in the chamber.

24. The device as claimed in claim 22, wherein the drainage channel is sealable by means of a closure body which is associated with the other chamber part and blocks the drainage channel in the closed position.

25. The device as claimed in claim 22, wherein one of the chamber parts is realized as a holder with a cavity for receiving the portion packaging and the other chamber part is realized as a closure part for closing the cavity and in that the drainage channel is arranged on the holder.

26. The device as claimed in claim 25, wherein the cavity has at least one drainage groove which, with reference to a longitudinal center axis, extends from the bottom of the cavity toward the opening thereof.

27. The device as claimed in claim 26, wherein the cavity, on the side of its opening, has a support shoulder, which is inclined with respect to the longitudinal center axis, for supporting a complementary wall part of the portion packaging, wherein the drainage groove opens out into the support shoulder and the drainage channel begins in the support shoulder or in a region which adjoins directly thereto.

28. The device as claimed in claim 22, wherein at least one chamber part has at least one penetration element for penetrating the portion packaging in the closed position.

29. The device as claimed in claim 22, wherein the cross section of the drainage channel is between 0.1 mm² and 10 mm².

30. The device as claimed in claim 22, wherein the drainage channel leads to a vessel for receiving liquid conducted away by means of the drainage channel.

31. The device as claimed in claim 22, wherein the receiving chamber is realized in a rotationally symmetrical manner and in that the drainage channel is realized as a radial bore in one of the chamber parts.

32. The device as claimed in claim 22, wherein in the region of the outlet opening of the drainage channel, a drip skirt is arranged on the chamber outside in such a manner that outflowing liquid can be conducted away along the drip skirt.

33. A capsule, consisting of a rotationally symmetrical capsule body having a side wall and having a bottom which is realized integrally with said side wall, as well as having a cover which covers the capsule body to form a closed capsule chamber which contains a substance for the preparation of a beverage, wherein for conducting through a liquid, the cover and the bottom can be penetrated by means which are arranged outside the capsule and are in a device as claimed in claim 22, wherein the side wall, in a region facing the cover, forms in cross section a circumferential shoulder which has at least one wall section which, with reference to the longitudinal center axis of the capsule, is inclined or curved in cross section, wherein the outside of the shoulder forms a circumferential sealing surface which can be pressed in a sealing manner against a complementary contact surface.

34. The capsule as claimed in claim 33, wherein the width (b) of the inclined or curved wall section is at least 1 mm and in that a height of the circumferential shoulder is at least 3.5 mm with reference to the longitudinal center axis.

35. The capsule as claimed in claim 33, wherein the inclined wall section is inclined by 45° with respect to the longitudinal center axis tapering toward the bottom.

36. The capsule as claimed in claim 33, wherein the side wall between the bottom and the shoulder is realized tapering toward the bottom.

37. The capsule as claimed in claim 33, wherein said capsule is deep-drawn from a film of plastics material or biopolymer or metal, wherein the bottom is realized so as to be resiliently deformable.

38. The device as claimed in claim 22 having a capsule as claimed in claim 12, wherein the drainage channel is sealed or is sealable in the closed position by means of the sealing surface of the circumferential shoulder.

39. The device as claimed in claim 38, wherein the side wall of the capsule is radially expandable under the effect of pressure and in that the drainage channel is sealable by means of the sealing surface of the expanded side wall.

40. The device as claimed in claim 27 having a capsule, consisting of a rotationally symmetrical capsule body having a side wall and having a bottom which is realized integrally with said side wall, as well as having a cover which covers the capsule body to form a closed capsule chamber which contains a substance for the preparation of a beverage, wherein the circumferential shoulder of the capsule rests on the support shoulder of the cavity and the sealing surface of the circumferential shoulder seals either the drainage groove or the drainage channel or both of these.

41. The device, in particular as claimed in claim 22, wherein at least one of the chamber parts has compression means which are directed against the receiving chamber and by means of which the portion packaging can be acted upon in the closed position.

42. The device as claimed in claim 41, characterized wherein the compression means comprise at least one resilient element which has a plurality of leaf springs which extend radially outward proceeding from a center and the resilient free ends of which act upon the portion packaging in the closed position, wherein penetration elements and/or further compression means are arranged on the wall element between individual or all of the leaf springs.

43. The device as claimed in claim 22, wherein the portion packaging is a capsule.

44. The capsule as claimed in claim 36, wherein the side wall between the bottom and the shoulder is inclined by an angle of 7° with respect to the longitudinal center axis.

45. The capsule as claimed in claim 37, wherein said capsule has a wall thickness of between 0.1 mm and 0.2 mm.
